(19) United States
(12) Patent Application Publication
(10) Pub. No.: US 2014/0340511 A1
(43) Pub. Date: Nov. 20, 2014

(54) Uniformity Testing System and Methodology for Utilizing the Same

(71) Applicant: Android Industries LLC, Auburn Hills, MI (US)

(72) Inventors: Lawrence J. Lawson, Troy, MI (US); Donald G. Straitiff, Howell, MI (US); Barry A. Clark, Ortonville, MI (US); Ramsey Richard Niazy, Clarkston, MI (US)

(73) Assignee: Android Industries LLC, Auburn Hills, MI (US)

(21) Appl. No.: 14/268,814

(22) Filed: May 2, 2014

Related U.S. Application Data
(60) Provisional application No. 61/823,261, filed on May 14, 2013.

(51) Int. Cl. G01N 21/88; G01N 21/84

(52) U.S. Cl. CPC G01N 21/8851; G01N 21/84; G01N 2021/8887
USPC 348/131

(57) ABSTRACT

A system for testing an implement is disclosed. The system includes: a computing resource, an implement rotating device, a light emitting device and a light receiving device. The implement rotating device rotatably-supports the implement. The implement rotating device is communicatively-coupled to the computing resource. The light emitting device is communicatively-coupled to the computing resource. The light receiving device is communicatively-coupled to the computing resource. The implement rotating device and the implement are arranged between the light emitting device and the light receiving device. The light emitting device and the light receiving device are substantially linearly-aligned with the implement rotating device and the such that upon activating the light emitting device, light that is emitted by the light emitting device is directed toward both of the implement and the light receiving device whereby the light receiving device captures an image corresponding to a portion of the light emitted by the light emitting device and a shadow formed by at least a portion of the implement. The shadow corresponds to another portion of the light that is not received by the light receiving device. The light receiving device communicates the captured image to the computing resource for determining uniformity or a lack of uniformity of the implement. A method for utilizing the system is also disclosed. A computer program product is also disclosed.

### CROSS-REFERENCE TO RELATED APPLICATIONS

This U.S. patent application claims priority to U.S. Provisional Application 61/823,261 filed on May 14, 2013, the disclosure of which is considered part of the disclosure of this application and is hereby incorporated by reference in its entirety.

### TECHNICAL FIELD

The disclosure relates to a uniformity testing system and methodology for utilizing the same.

### BACKGROUND

It is known in the art to assemble a tire-wheel assembly in several steps. Usually, conventional methodologies that conduct such steps require a significant capital investment and human oversight. The present invention overcomes drawbacks associated with the prior art by setting forth a simple system and method associated with one or more steps for assembling a tire-wheel assembly.

### SUMMARY

One aspect of the disclosure provides a system for testing an implement. The system may include a computing resource, an implement rotating device, a light emitting device and a light receiving device. The implement rotating device rotatably-supports the implement. The implement rotating device may be communicatively-coupled to the computing resource. The light emitting device may be communicatively-coupled to the computing resource. The light receiving device may be communicatively-coupled to the computing resource. The implement rotating device and the implement may be arranged between the light emitting device and the light receiving device. The light emitting device and the light receiving device may be substantially linearly-aligned with the implement rotating device and the implement such that upon activating the light emitting device, light that is emitted by the light emitting device may be directed toward both of the implement and the light receiving device whereby the light receiving device captures an image corresponding to a portion of the light emitted by the light emitting device and a shadow formed by at least a portion of the implement. The shadow corresponds to another portion of the light that may not be received by the light receiving device. The light receiving device communicates the captured image to the computing resource for determining uniformity or a lack of uniformity of the implement.

Implementations of the disclosure may include the captured image being a bi-pixel digital image.

Additionally, the light receiving device may be a digital optical imaging device that creates the bi-pixel digital image.

In some examples, the digital optical imaging device may be a charge coupled device that converts the bi-pixel digital image into an electronic signal that may be communicated from the charge coupled device to the computing resource for contributing to a determination of uniformity or a lack of uniformity of the implement.

In some implementations, the computing resource may be wirelessly communicatively-coupled to one or more of: the implement rotating device, the light emitting device and the light receiving device.

In other implementations, the computing resource may be hardwired to one or more of: the implement rotating device, the light emitting device and the light receiving device by one or more electrical communication conduits.

In some instances, the implement rotating device includes: an implement supporting portion having a proximal end and a distal end; and a rotator connected to a proximal end of the implement supporting portion. The distal end of the implement supporting portion may be connected to the implement. The rotator imparts rotation to the implement supporting portion and the implement.

Implementations of the disclosure may include the implement being one of a wheel, a tire, a non-inflated tire-wheel assembly and an inflated tire-wheel assembly.

Additionally, the rotator may be one of a hydraulic motor, a pneumatic motor and an electric motor.

In some examples, the computing resource may control the rotator for adjusting the rotational speed of the implement supporting portion.

In some implementations, the implement rotating device further includes an angular rotation detector that may be disposed upon or connected to the implement supporting portion. The angular rotation detector includes one of an optical disk and magnetic counter.

In other implementations, the computing resource receives information associated with or generated by the angular rotation detector that contributes to a determination of uniformity or a lack of uniformity of the implement.

In some instances, the light emitting device may be one of: an incandescent light source, a light emitting diode (LED) light source, an infrared light source, a flash lamp, a laser light and a halogen light that emits visible or non-visible light.

Additionally, the system includes one or more pedestals that may be spatially adjustable in an X-Y-Z direction. The one or more pedestals may be connected to one or more of: the implement rotating device, the light emitting device and the light receiving device for selectively adjusting a spatial orientation of one or more of the implement rotating device, the light emitting device and the light receiving device.

Another aspect of the disclosure provides a method for utilizing a system. The method may include the steps of: arranging an implement rotating device between a light emitting device and a light receiving device; arranging an implement upon a implement supporting portion of the implement rotating device; activating the light emitting device for directing emitted light from the light emitting device toward both of the implement and the light receiving device; receiving a first portion of the emitted light upon at least a surface portion of the implement and receiving a second portion of the emitted light upon the light receiving device such that the implement casts a shadow upon the light receiving device; activating a rotating device of the implement supporting portion for imparting rotation to both of the implement supporting portion and the implement; utilizing the light receiving device for capturing at least one image defined by the second portion of the emitted light and the shadow formed by the implement over at least one full revolution of the implement; utilizing the computing device for analyzing the captured at least one image for determining uniformity or a lack of uniformity of the implement.

Implementations of the disclosure may include after activating the rotating device, the method includes the step of: increasing rotational speed of the implement supporting portion; and after increasing the rotational speed of the implement supporting portion, the method may include the step of: determining if the implement supporting portion has reached a predetermined rotational speed, and, if the implement supporting portion has not yet reached the predetermined rotational speed, the method may be looped back to the increasing the rotational speed step, and, upon the implement supporting portion reaching the predetermined rotational speed, the method may exit the loop for advancement to the capturing at least one image step.

Additionally, the method may further include the step of: utilizing an angular rotation detector attached to the implement rotating device for encoding an angular position of the implement as the implement rotates through a rotational cycle for synchronize each captured image of a series of captured images with an absolute angular position of the implement.

In some examples, the capturing at least one image step may include capturing images a frame rate ranging between approximately 30 frames-per-second and 1,000 frames-per-second.

In some implementations, the captured at least one image may be at least one bi-pixel digital image.

In other implementations, the light receiving device may be a digital optical imaging device that creates the at least one bi-pixel digital image.

In some instances, the digital optical imaging device may be a charge coupled device that converts the at least one bi-pixel digital image into an electronic signal. The method may also include the step of communicating the at least one bi-pixel digital image from the charge coupled device the computing resource.

In still yet another aspect of the disclosure provides a computer program product encoded on a non-transitory computer readable storage medium comprising instructions that when executed by a data processing apparatus cause the data processing apparatus to perform operations. The operations may include: activating a light emitting device for directing emitted light from the light emitting device toward both of an implement and a light receiving device such that a first portion of the emitted light is received upon at least a surface portion of the implement and receiving a second portion of the emitted light upon the light receiving device such that the implement casts a shadow upon the light receiving device; activating a rotating device of the implement supporting portion for imparting rotation to both of the implement supporting portion and the implement and capturing at least one image defined by the second portion of the emitted light and the shadow formed by the implement over at least one full revolution of the implement; communicating the at least one captured image from the light receiving device to a computing resource; and analyzing the captured at least one image for determining uniformity or a lack of uniformity of the implement.

Implementations of the disclosure may include after activating the rotating device, the computer program product includes further operations comprising: increasing rotational speed of the implement supporting portion; and after increasing the rotational speed of the implement supporting portion, determining if the implement supporting portion has reached a predetermined rotational speed, and, if the implement supporting portion has not yet reached the predetermined rotational speed, further increasing the rotational speed, and, upon the implement supporting portion reaching the predetermined rotational speed, performing the step of capturing the at least one image.

Additionally, the operations may include: encoding an angular position of the implement as the implement rotates through a rotational cycle for synchronize each captured image of a series of captured images with an absolute angular position of the implement.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a perspective view of an exemplary uniformity testing system interfaced with a wheel.

FIG. 1B is a perspective view of an exemplary uniformity testing system interfaced with a tire.

FIG. 1C is a perspective view of an exemplary uniformity testing system interfaced with a non-inflated tire-wheel assembly.

FIG. 1D is a perspective view of an exemplary uniformity testing system interfaced with an inflated tire-wheel assembly.

FIG. 2A is a view of a portion of a light receiving device of the system of FIG. 1A showing an image corresponding to a wheel that is rotationally balanced, uniform, or in some other way non-defective for its intended purpose.

FIG. 2A′ is a view of a portion of a light receiving device of the system of

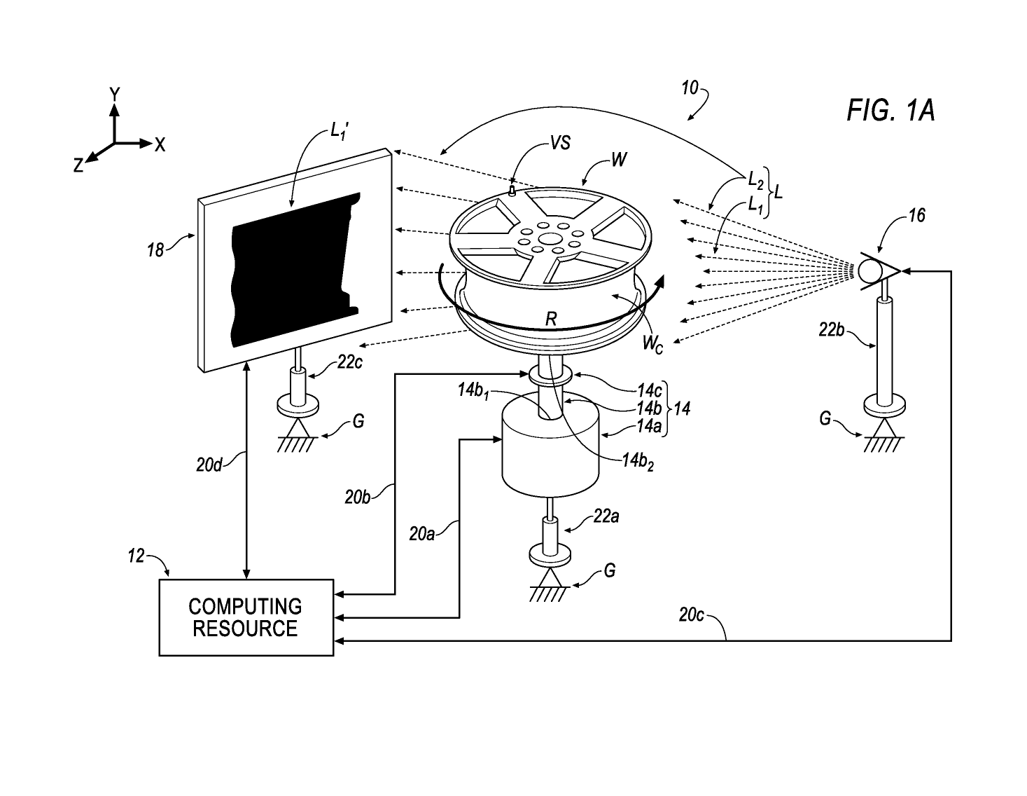

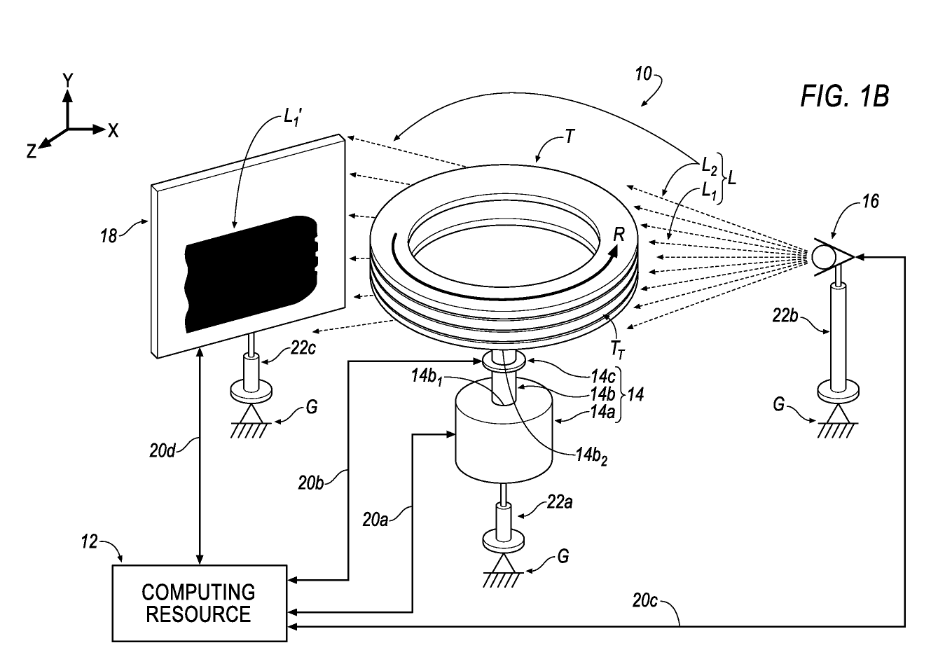

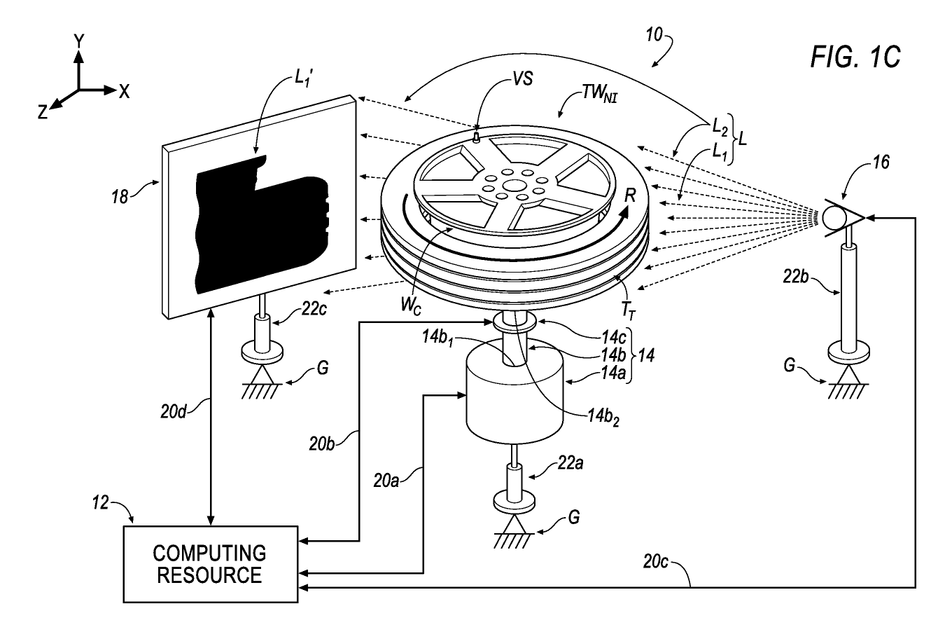

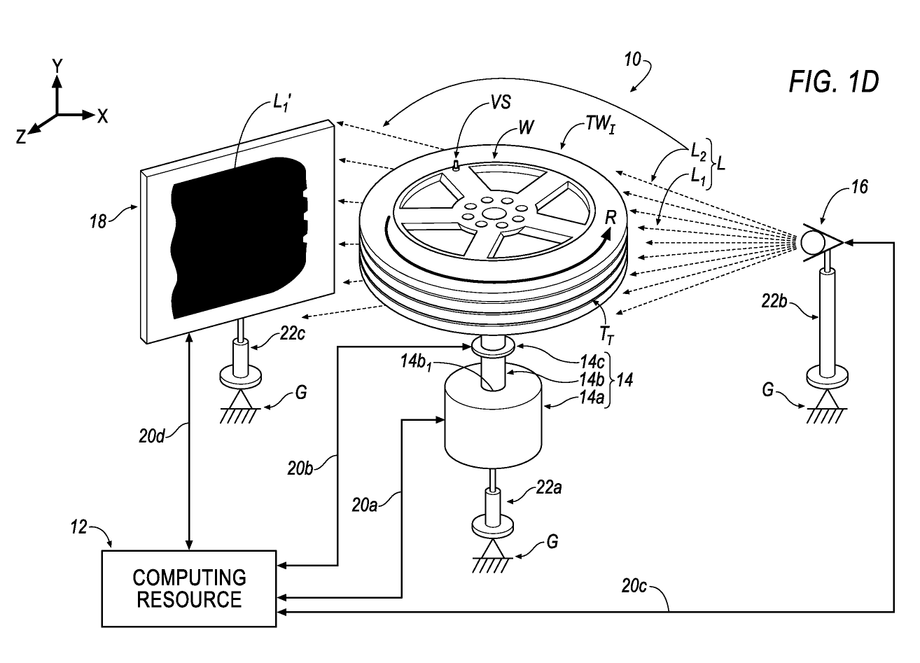

FIG. 1A showing an image corresponding to a wheel that is rotationally out of balance, non-uniform, or in some other way defective for its intended purpose.

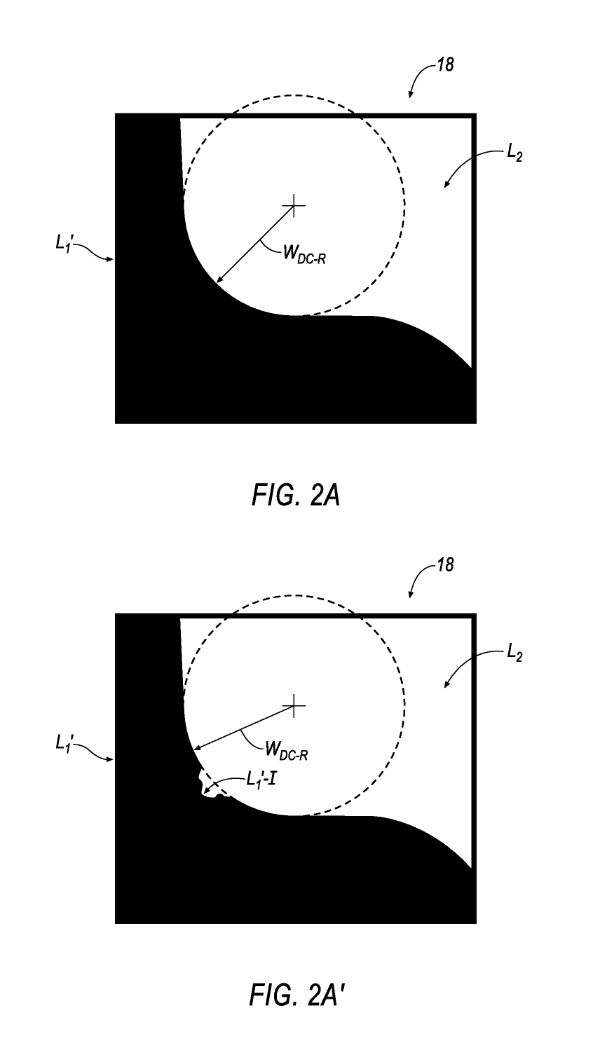

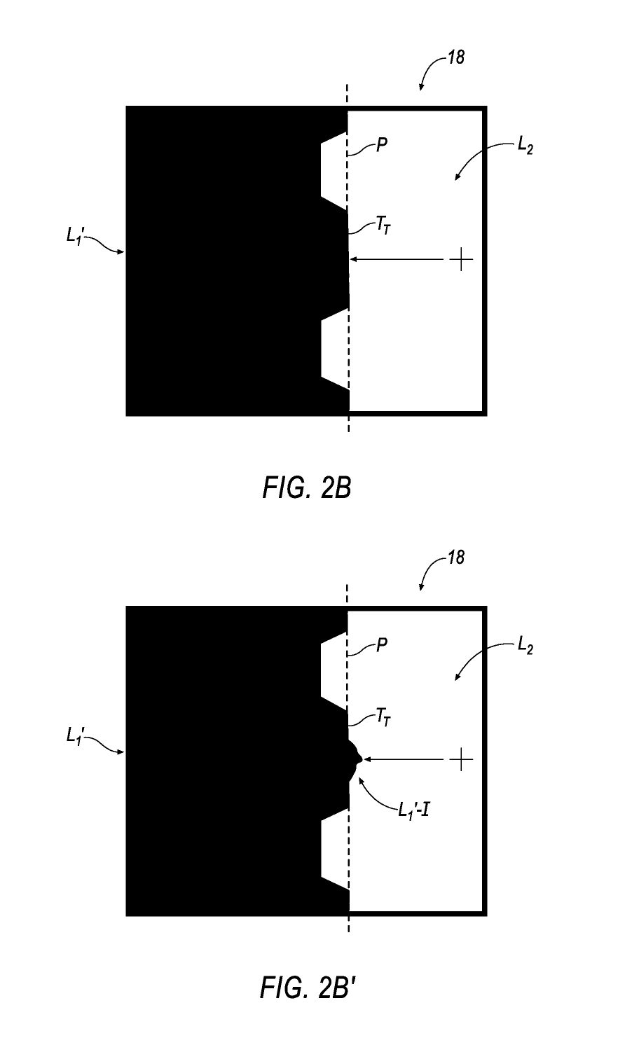

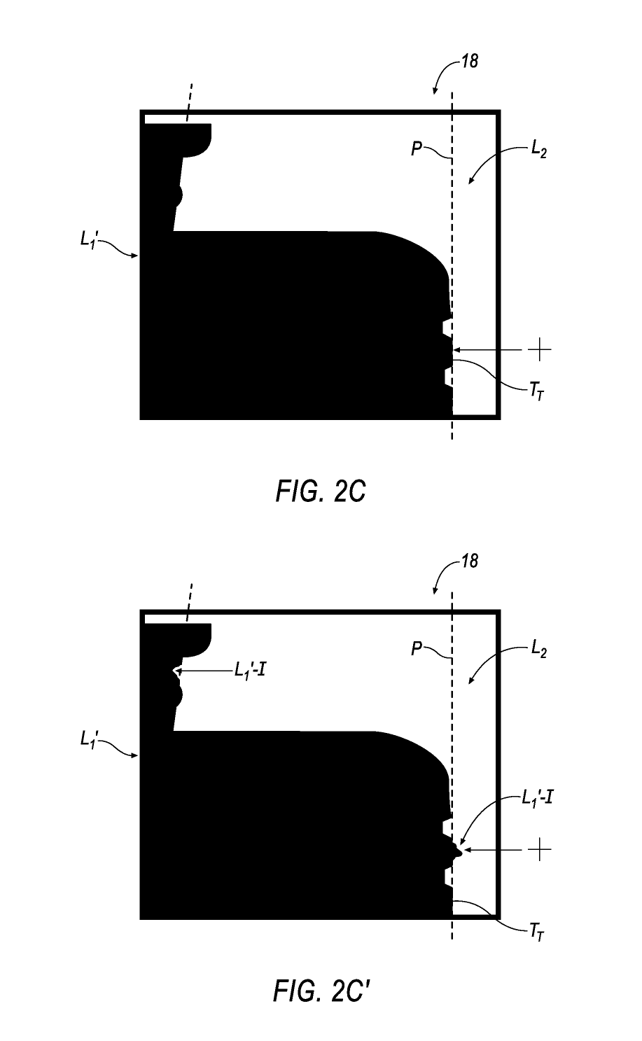

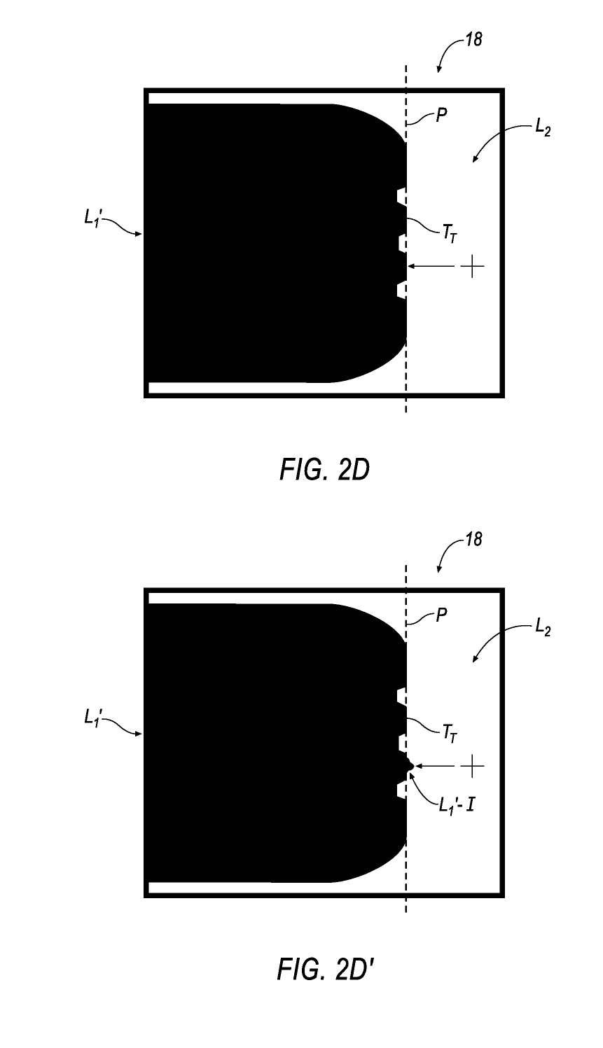

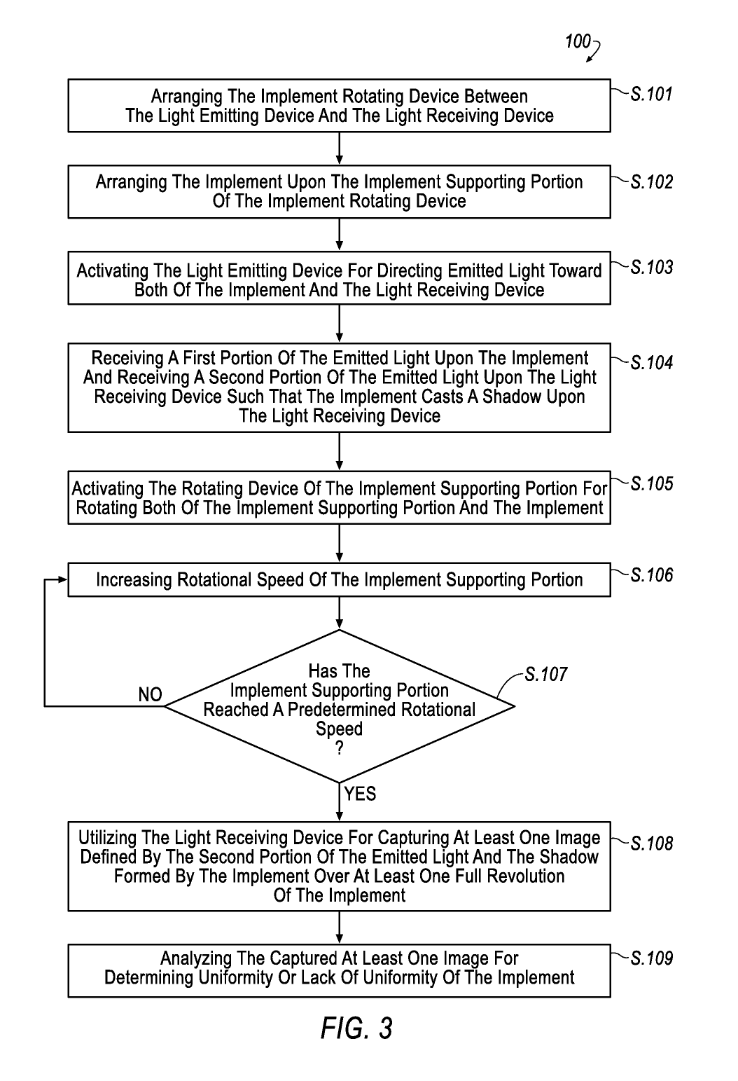

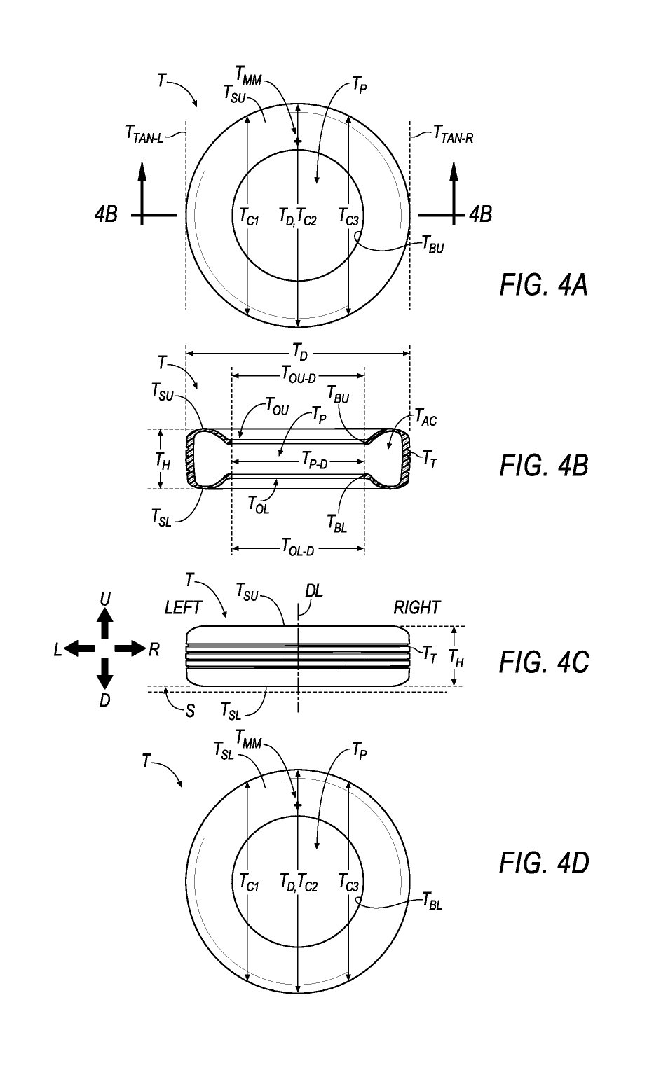

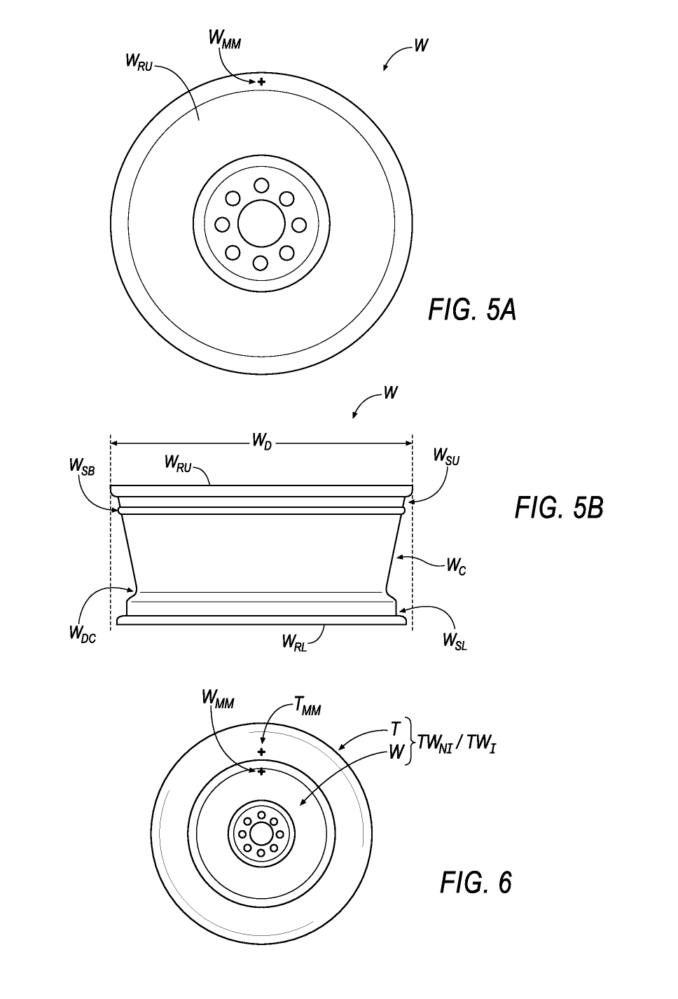

FIG. 2B is a view of a portion of a light receiving device of the system of FIG. 1B showing an image corresponding to a tire that is rotationally balanced, uniform, or in some other way non-defective for its intended purpose.

FIG. 2B′ is a view of a portion of a light receiving device of the system of FIG. 1B showing an image corresponding to a tire that is rotationally out of balance, non-uniform, or in some other way defective for its intended purpose.

FIG. 2C is a view of a portion of a light receiving device of the system of FIG. 1C showing an image corresponding to a non-inflated tire-wheel assembly that is rotationally balanced, uniform, or in some other way non-defective for its intended purpose.

FIG. 2C′ is a view of a portion of a light receiving device of the system of FIG. 1C showing an image corresponding to a non-inflated tire-wheel assembly that is rotationally out of balance, non-uniform, or in some other way defective for its intended purpose.

FIG. 2D is a view of a portion of a light receiving device of the system of FIG. 1D showing an image corresponding to an inflated tire-wheel assembly that is rotationally balanced, uniform, or in some other way non-defective for its intended purpose.

FIG. 2D′ is a view of a portion of a light receiving device of the system of FIG. 1D showing an image corresponding to an inflated tire-wheel assembly that is rotationally out of balance, non-uniform, or in some other way defective for its intended purpose.

FIG. 3 is a flow diagram of an exemplary method for utilizing the system of FIGS. 1A-1D.

FIG. 4A is a top view of an exemplary tire.

FIG. 4B is a cross-sectional view of the tire according to line 4B-4B of FIG. 4A.

FIG. 4C is a side view of the tire of FIG. 4A.

FIG. 4D is a bottom view of the tire of FIG. 4A.

FIG. 5A is a top view of an exemplary wheel.

FIG. 5B is a side view of the wheel of FIG. 5A.

FIG. 6 is a top view of the tire of FIGS. 4A-4D joined to the wheel of FIGS. 5A-5B.

Like reference symbols in the various drawings indicate like elements.

### DETAILED DESCRIPTION

Prior to describing embodiments of the invention, reference is made to FIGS. 4A-4D, which illustrates an exemplary tire, T. Further, in describing embodiments of the invention in the present disclosure, reference may be made to the “upper,” “lower,” “left,” “right” and “side” of the tire, T; although such nomenclature may be utilized to describe a particular portion or aspect of the tire, T, such nomenclature may be adopted due to the orientation of the tire, T, with respect to structure (e.g., an implement rotating device 14) that supports/engages the tire, T. Accordingly, the above nomenclature should not be utilized to limit the scope of the claimed invention and is utilized herein for exemplary purposes in describing an embodiment of the invention.

In an embodiment, the tire, T, includes an upper sidewall surface, T_{SU} (see, e.g., FIG. 4A), a lower sidewall surface, T_{SL} (see, e.g., FIG. 4D), and a tread surface, T_{T} (see, e.g., FIGS. 4B-4C), that joins the upper sidewall surface, T_{SU}, to the lower sidewall surface, T_{SL}. Referring to FIG. 4B, the upper sidewall surface, T_{SU}, may rise away from the tread surface, T_{T}, to a peak and subsequently descend at a slope to terminate at and form a circumferential upper bead, T_{BU}; similarly, the lower sidewall surface, T_{SL}, may rise away from the tread surface, T_{T}, to a peak and subsequently descend at a slope to terminate at and form a circumferential lower bead, T_{BL}. The tread surface, T_{T}, may also define a height, T_{H}, of the tire, T, that extends between the upper sidewall surface, T_{SU}, and the lower sidewall surface, T_{SL}.

As seen in FIG. 4B, when the tire, T, is in a relaxed, unbiased state, the upper bead, T_{BU}, forms a circular, upper tire opening, T_{OU}; similarly, when the tire, T, is in a relaxed, unbiased state, the lower bead, T_{BL}, forms a circular, lower tire opening, T_{OL}. It will be appreciated that when an external force is applied to the tire, T, the tire, T, may be physically manipulated, and, as a result, one or more of the upper tire opening, T_{OU}, and the lower tire opening, T_{OL}, may be temporality upset such that one or more of the upper tire opening, T_{OU}, and the lower tire opening, T_{OL}, is/are not entirely circular, but, may, for example, be manipulated to include a non-circular shape, such as, for example, an oval shape.

Referring to FIG. 4B, when in the relaxed, unbiased state, each of the upper tire opening, T_{OU}, and the lower tire opening, T_{OL}, form, respectively, an upper tire opening diameter, T_{OU-D}, and a lower tire opening diameter, T_{OL-D}. Further, as seen in FIGS. 4A-4B, when in the relaxed, unbiased state, the upper sidewall surface, T_{SU}, and the lower sidewall surface, T_{SL}, define the tire, T, to include a tire diameter, T_{D}.

Referring to FIGS. 4A-4B and 4D, the tire, T, also includes a passage, T. Access to the passage, T_{P}, is permitted by either of the upper tire opening, T_{OU}, and the lower tire opening, T_{OL}. Referring to FIG. 4B, when the tire, T, is in a relaxed, unbiased state, the upper tire opening, T_{OU}, and the lower tire opening, T_{OL}, define the passage, T_{P}, to include a diameter, T_{P-D}. Referring also to FIG. 4B, the tire, T, includes a circumferential air cavity, T_{AC}, that is in communication with the passage, T. After joining the tire, T, to a wheel, W, pressurized air is deposited into the circumferential air cavity, T_{AC}, for inflating the tire, T.

Further, when the tire, T, is arranged adjacent structure or a wheel, W (see, e.g., FIGS. 5A-5B), as described in the following disclosure, the written description may reference a “left” portion or a “right” portion of the tire, T. Referring to FIG. 4C, the tire, T, is shown relative to a support member, S; the support member, S, is provided (and shown in phantom) in order to establish a frame of reference for the “left” portion and the “right” portion of the tire, T. In FIG. 4C, the tire, T, is arranged in a “non-rolling” orientation such that the tread surface, T_{T}, is not disposed adjacent the phantom support member, S, but, rather the lower sidewall surface, T_{SL}, is disposed adjacent the phantom support member, S. A center dividing line, DL, equally divides the “non-rolling” orientation of the tire, T, in half in order to generally indicate a “left” portion of the tire, T, and a “right” portion of the tire, T.

As discussed above, reference is made to several diameters, T_{P-D}, T_{OU-D}, T_{OL-D} of the tire, T. According to geometric theory, a diameter passes through the center of a circle, or, in the present disclosure, the axial center of the tire, T, which may alternatively be referred to as an axis of rotation of the tire, T. Geometric theory also includes the concept of a chord, which is a line segment that whose endpoints both lie on the circumference of a circle; according to geometric theory, a diameter is the longest chord of a circle.

In the following description, the tire, T, may be moved relative to structure; accordingly, in some instances, a chord of the tire, T, may be referenced in order to describe an embodiment of the invention. Referring to FIG. 4A, several chords of the tire, T, are shown generally at T_{C1}, T_{C2} (i.e., the tire diameter, T_{D}) and T_{C3}.

The chord, T_{C1}, may be referred to as a “left” tire chord. The chord, T_{C3}, may be referred to as a “right” tire chord. The chord, T_{C2}, may be equivalent to the tire diameter, T_{D}, and be referred to as a “central” chord. Both of the left and right tire chords, T_{C1}, T_{C3}, include a geometry that is less than central chord, T_{C2},/tire diameter, T_{D}.

In order to reference the location of the left chord, T_{C1}, and the right chord, T_{C3}, reference is made to a left tire tangent line, T_{TAN-L}, and a right tire tangent line, T_{TAN-R}. The left chord, T_{C1}, is spaced apart approximately one-fourth (¼) of the tire diameter, T_{D}, from the left tire tangent line, T_{TAN-L}. The right chord, T_{C3}, is spaced apart approximately one-fourth (¼) of the tire diameter, T_{D}, from the right tire tangent line, T_{TAN-R}. Each of the left and right tire chords, T_{C1}, T_{C3}, may be spaced apart about one-fourth (¼) of the tire diameter, T_{D}, from the central chord, T_{C2}. The above spacings referenced from the tire diameter, T_{D}, are exemplary and should not be meant to limit the scope of the invention to approximately a one-fourth (¼) ratio; accordingly, other ratios may be defined, as desired.

Further, as will be described in the following disclosure, the tire, T, may be moved relative to structure. Referring to FIG. 4C, the movement may be referenced by an arrow, U, to indicate upwardly movement or an arrow, D, to indicate downwardly movement. Further, the movement may be referenced by an arrow, L, to indicate left or rearwardly movement or an arrow, R, to indicate right or forwardly movement.

Prior to describing embodiments of the invention, reference is made to FIGS. 5A-5B, which illustrate an exemplary wheel, W. Further, in describing embodiments of the invention in the present disclosure, reference may be made to the “upper,” “lower,” “left,” “right” and “side” of the wheel, W; although such nomenclature may be utilized to describe a particular portion or aspect of the wheel, W, such nomenclature may be adopted due to the orientation of the wheel, W, with respect to structure (e.g., an implement rotating device 14) that supports/engages the wheel, W.

Accordingly, the above nomenclature should not be utilized to limit the scope of the claimed invention and is utilized herein for exemplary purposes in describing an embodiment of the invention.

In an embodiment, the wheel, W, includes an upper rim surface, W_{RU}, a lower rim surface, W_{RL}, and an outer circumferential surface, W_{C}, that joins the upper rim surface, W_{RU}, to the lower rim surface, W_{RL}. Referring to FIG. 5B, the upper rim surface, W_{RU}, forms a wheel diameter, W_{D}. The wheel diameter, W_{D}, may be non-constant about the circumference, W_{C}, from the upper rim surface, W_{RU}, to the lower rim surface, W_{RL}. The wheel diameter, W_{D}, formed by the upper rim surface, W_{RU}, may be largest diameter of the non-constant diameter about the circumference, W_{C}, from the upper rim surface, W_{RU}, to the lower rim surface, W_{RL}. The wheel diameter, W_{D}, is approximately the same as, but slightly greater than the diameter, T_{P-D}, of the passage, T_{P}, of the tire, T; accordingly, once the wheel, W, is disposed within the passage, T_{P}, the tire, T, may flex and be frictionally-secured to the wheel, W, as a result of the wheel diameter, W_{D}, being approximately the same as, but slightly greater than the diameter, T_{P-D}, of the passage, T_{P}, of the tire, T.

The outer circumferential surface, W_{C}, of the wheel, W, further includes an upper bead seat, W_{SU}, and a lower bead seat, W_{SL}. The upper bead seat, W_{SU}, forms a circumferential cusp, corner or recess that is located proximate the upper rim surface, W_{RU}. The lower bead seat, W_{SL}, forms a circumferential cusp, corner or recess that is located proximate the lower rim surface, W_{RL}. Upon inflating the tire, T, the pressurized air causes the upper bead, T_{BU}, to be disposed adjacent and “seat” in the upper bead seat, W_{SU}; similarly, upon inflating the tire, T, the pressurized air causes the lower bead, T_{BL}, to be disposed adjacent and “seat” in the lower bead seat, W_{SL}. In some circumstances, after inflation of the tire, T, entrapments (not shown), such as, for example, contaminants, lubricant or the like, may be trapped between the bead, T_{BU}/T_{BL}, of the tire, T, and the bead seat W_{SU}/W_{SL} of the wheel, W; the entrapments may be removed after the inflated tire-wheel assembly, TW_{I}, is subjected to a bead exerciser (not shown).

The non-constant diameter of the outer circumference, W_{C}, of the wheel, W, further forms a wheel “drop center,” W_{DC}. A wheel drop center, W_{DC}, may include the smallest diameter of the non-constant diameter of the outer circumference, W_{C}, of the wheel, W. Functionally, the wheel drop center, W_{DC}, may assist in the mounting of the tire, T, to the wheel, W.

The non-constant diameter of the outer circumference, W_{C}, of the wheel, W, further forms an upper “safety bead,” W_{SB}. In an embodiment, the upper safety bead may be located proximate the upper bead seat, W_{SU}. In the event that pressurized air in the circumferential air cavity, T_{AC}, of the tire, T, escapes to atmosphere, the upper bead, T_{BU}, may “unseat” from the upper bead seat, W_{SU}; because of the proximity of the safety bead, W_{SB}, the safety bead, W_{SB}, may assist in the mitigation of the “unseating” of the upper bead, T_{BU}, from the upper bead seat, W_{SU}, by assisting in the retaining of the upper bead, T_{BU}, in a substantially seated orientation relative to the upper bead seat, W_{SU}. In some embodiments, the wheel, W, may include a lower safety bead (not shown); however, upper and/or lower safety beads may be included with the wheel, W, as desired, and are not required in order to practice the invention described in the following disclosure.

With reference now to FIGS. 4A and 5A, physical attributes of the tire, T, and the wheel, W, are described. It should be noted that the discussed physical attributes may be inherent aspects/characteristics of each of the tire, T, and the wheel, W, which may arise from, for example, a manufacturing technique (e.g., molding, casting or the like) of each of the tire, T, and the wheel, W.

As seen in FIG. 4A, the tire, T, may include an inherent physical attribute that is referred to as a “high point of radial force variation” (see T_{MM}). When the tire, T, is in use, the high point of radial force variation may be described as a region of the tire, T, where there is a fluctuation in force that appears in the rotating axis of the tire, T, when a specific load is applied, and, when the tire, T, is rotated at a specific speed.

Referring to FIG. 5A, the wheel, W, may include an inherent physical attribute that is referred to as a “point of minimum radial run out” (see W_{MM}). To a certain extent, about every wheel, W, may be manufactured with an inherent imperfection (which may arise from, for example, material distribution and/or flow of material during the manufacturing process of the wheel, W). Accordingly, the imperfection of the wheel, W, may result in the wheel, W, being “out-of-round,” or, having a “run-out” (i.e., the wheel, W, therefore, may include the aforementioned “point of minimum radial run out”).

When the tire, T, and the wheel, W, are joined (i.e., mounted) together as seen in FIG. 6, it may be desirable to align (or match) the high point of radial force variation, T_{MM}, of the tire, T, with the point of minimum radial run out, W_{MM}, of the wheel, W. The alignment or “matching” described above may, for example, improve stability of a vehicle to which an inflated tire-wheel assembly, TW_{I}, is joined to and/or mitigate abnormal tread-wear patterns to the tire, T. The alignment or “matching” of the high point of radial force variation of the tire, T, with the point of minimum radial run out of the wheel, W, may be referred to as a “uniformity method” of “match mounting.”

If, however, one or more of the high point of radial force variation, T_{MM}, of the tire, T, and the point of minimum radial run out, W_{MM}, of the wheel, W, are not determined or identified by, for example, an original equipment supplier, at the time the tire, T, and the wheel, W, are to be joined (i.e., mounted) together, one (e.g., a person or business entity) may have to determine or locate a point of lightest weight (see T_{MM}) of the tire, T, and/or a point of heaviest weight (see W_{MM}) of the wheel, W; upon determining/locating the above-described lightest/heaviest points, a substantially similar alignment/“matching” is conducted as described above prior to joining (i.e., mounting) the tire, T, and the wheel, W. In some circumstances, if a valve-stem hole (see W_{MM}) is provided on the wheel, W, the point of lightest weight of the tire, T, may be aligned with the valve stem hole on the wheel, W (rather than aligning the point of lightest weight of the tire, T, with the point of heaviest weight of the wheel, W). The alignment of the point of lightest weight of the tire, T, with the valve stem hole/point of heaviest weight of the wheel, W, may be referred to as a “weight method” of “match mounting.”

For purposes of describing an embodiment of either of the “uniformity method” or the “weight method” of “match mounting,” reference is made to FIGS. 4A, 5A and 6 where: 1) a region of the tire, T, is identified by the reference numeral “T_{MM}” and 2) a region of the wheel, W, is identified by the reference numeral “W_{MM}.” The subscript “MM” for each of the reference numerals T_{MM} and W_{MM} may generally stand for “match mark,” and, may be utilized in one of the “uniformity method” or “weight method” for “match mounting” the tire, T, and the wheel, W, together to form a “match-mounted” non-inflated tire-wheel assembly, TW_{NI}. Accordingly, if a “uniformity method” is employed in the described match mounting embodiment: 1) the reference numeral “T_{MM}” may stand for a region of high point of radial force variation of the tire, T, and 2) the reference numeral W_{MM} may stand for a region of point of minimum radial run out of the wheel, W. Alternatively, if a “weight method” is employed in the described match mounting embodiment: 1) the reference numeral “T_{MM}” may stand for a point of lightest weight of the tire, T, and 2) the reference numeral W_{MM} may stand for a point of heaviest weight of the wheel, W, or, a location of a valve stem hole of the wheel, W.

In describing one or more of the match mounting embodiments of the invention, the illustrated “dot” or “spot” seen in the Figures that the reference signs, T_{MM}, and, W_{MM}, point to should not be construed to be limited to a physical/visible/tactile markings on one or more of the tire, T, and the wheel, W. In some conventional match-marking/match-mounting systems/methodologies, the tire, T, and the wheel, W, may include, for example, a physical marking, object or the like, such as, for example, a paint dot, a tag, a sticker, an engraving, an embossment or the like that is applied to or formed in, upon or within a surface or body portion of one or more of a tire, T, and a wheel, W. However, in one or more alternative embodiments of the present invention, match-mounting techniques may not include any kind of or type of a physical/visible/tactile marking applied to either of the tire, T, and the wheel, W; accordingly, one of, or, many benefits realized by the present invention may be that additional material, time or steps associated with the application and/or formation of the physical marking, object or the like upon one or more of the tire, T, and the wheel, W, is obviated, thereby realizing a cost and/or time savings benefit in the assembling of a non/inflated tire-wheel assembly, TW_{NI}/TW_{I}. If a physical marking, object or the like is not included on either of the tire, T, and the wheel, W, the spatial region of where the physical marking, object or the like may otherwise be located may be initially unknown to a processing apparatus, but, after one or more processing steps, the spatial region of where the physical marking, object or the like would otherwise by located may become known to/detected/learned by, for example, a computer or microprocessor associated with, for example, the apparatus.

Referring now to FIG. 1A, an exemplary uniformity testing system is shown generally at 10. An implement, (such as, for example, a wheel, W) is interfaced with the uniformity testing system 10 such that the uniformity testing system 10 may obtain information related to the wheel, W, such as, for example: (1) if the wheel, W, is rotationally balanced, uniform, or in some other way non-defective for its intended purpose (as seen in FIG. 2A), or, alternatively (2) if the wheel, W, is rotationally out of balance, non-uniform, or in some other way defective for its intended purpose (as seen in FIG. 2A′). In some implementations, the uniformity testing system 10 includes, but is not limited to: a computing resource 12 such as a digital computer, an implement rotating device 14, a light emitting device 16 and a light receiving device 18.

Although the following disclosure described an exemplary embodiment where the implement is a wheel, W, the system 10 is not limited to an implement being a wheel, W. For example, the implement may be, but is not limited to: a tire, T (see, e.g., FIG. 1B), a non-inflated tire-wheel assembly, TW_{NI} (see, e.g., FIG. 1C), and an inflated tire-wheel assembly, TW_{I} (see, e.g., FIG. 1D). Accordingly, the system 10 may operate in a substantially similar manner as described above by obtaining information related to the tire, T, or non-inflated tire-wheel assembly, TW_{NI}, or inflated tire-wheel assembly, TW_{I}, in order to determine if, for example: (1) the tire, T, or non-inflated tire-wheel assembly, TW_{NI}, or inflated tire-wheel assembly, TW_{I}, is rotationally balanced, uniform, or in some other way non-defective for its intended purpose (as seen, respectively, in FIGS. 2B, 2C and 2D), or, alternatively (2) if the tire, T, or non-inflated tire-wheel assembly, TW_{NI}, or inflated tire-wheel assembly, TW_{I}, is rotationally out of balance, non-uniform, or in some other way defective for its intended purpose (as seen, respectively, in FIGS. 2B′, 2C′ and 2D′). If the tire, T, for example, is rotationally out of balance, non-uniform, or in some other way defective for its intended purpose, a portion of the tread surface, T_{T}, of the tire, T, may project radially beyond a plane, P, that extends across each tread of the tread surface, T_{T}. If the wheel, W, for example is rotationally out of balance, non-uniform, or in some other way defective for its intended purpose, a portion of the outer circumference, W_{C}, of the wheel, W, may include a depression or pitting that may extend into the outer circumference, W_{C}, of the wheel, W, which may upset, for example, a true radius, W_{DC-R}, of a wheel drop-center, W_{DC}, of the wheel, W.

Referring to FIG. 1A, the computing resource 12 may include, but is not limited to: one or more electronic digital processors or central processing units (CPUs) in communication with one or more storage resources (e.g., memory, flash memory, dynamic random access memory (DRAM), phase change memory (PCM), and/or disk drives having spindles)). The computing resource 12 may be communicatively-coupled (e.g., wirelessly or hardwired by, for example, one or more electrical communication conduits 20a-20d) to each of the implement rotating device 14, the light emitting device 16 and the light receiving device 18 in order to, for example, activate or deactivate one or more of the implement rotating device 14, the light emitting device 16 and the light receiving device 18. Further, as will be described in the following disclosure, the computing resource 12 may be communicatively-coupled (e.g., wirelessly or hardwired by, for example, one or more of the electrical communication conduits 20a-20d) to each of the implement rotating device 14, the light emitting device 16 and the light receiving device 18 in order to, for example, receive information associated with or generated by one or more of the implement rotating device 14, the light emitting device 16 and the light receiving device 18; the information associated with or generated by one or more of the implement rotating device 14, the light emitting device 16 and the light receiving device 18 may contribute to a determination of uniformity (as seen, e.g., in FIG. 2A) or a lack of uniformity (as seen, e.g., in FIG. 2A′) of the wheel, W.

The wheel, W, is shown removably-supported by the implement rotating device 14. A mandrel, chuck, collet, end effector, or the like (not shown) or other attachment device may be used to couple shaft 14b to wheel, W, tire, T, or tire-wheel assembly TW_{I}. The implement rotating device 14 may include a rotator 14a connected to an implement supporting portion 14b. The rotator 14a may include, but is not limited to: a hydraulic motor, a pneumatic motor or an electric motor. The implement supporting portion 14b may include a shaft having a proximal end 14b₁ and a distal end 14b₂. The proximal end 14b₁ of the shaft 14b may be connected to the rotator 14a, and, the distal end 14b₂ of the shaft 14b supports the wheel, W. In some instances, the distal end 14b₂ of the shaft 14b may include implement securing structure (not shown) that permits the wheel, W, to be removably-coupled to the distal end 14b₂ of the shaft 14b. When the wheel, W, is disposed upon the distal end 14b₂ of the shaft 14b, any rotation imparted to the shaft 14b by the rotator 14a is correspondingly-imparted to the wheel, W.

The implement rotating device 14 may also include an angular rotation detector 14c. The angular rotation detector 14c may be disposed upon or connected to the implement supporting portion 14b. The angular rotation detector 14c may include, but is not limited to: optical disks, magnetic counters, and the like. Detector 14c may be used to determine one or more of the following: angular position, angular velocity, angular acceleration.

The computing resource 12 may be communicatively-coupled (e.g., wirelessly or hardwired by, for example, the electrical communication conduit 20a) to the rotator 14a in order to activate or deactivate the rotator 14a. The computing resource 12 may also be communicatively-coupled (e.g., wirelessly or hardwired by, for example, the electrical communication conduit 20b) to the implement rotating device 14 in order to receive information associated with or generated by angular rotation detector 14c; as will be described in the following disclosure, the information associated with or generated by angular rotation detector 14c may contribute to a determination of uniformity (as seen, e.g., in FIG. 2A) or a lack of uniformity (as seen, e.g., in FIG. 2A′) of the wheel, W. In some instances, the information associated with or generated by angular rotation detector 14c may be related to an angular position of the implement supporting portion 14b, and, correspondingly, an angular position of the wheel, W, as the implement supporting portion 14b and the wheel, W, are rotated through a 360° rotation cycle imparted by the rotator 14a. By providing the angular position of the implement supporting portion 14b, and, correspondingly, the angular position of the wheel, W, the computing resource 12 may pair one or more detected imperfections of the wheel, W (as seen in, e.g., FIG. 2A′), with (a) corresponding one or more angular location(s) of the wheel, W, over a full 360° revolution of the wheel, W.

The light emitting device 16 may be any desirable light source that emits a light, L, that is registerable (readable) by the light receiving device 18. The light emitting device 16 may include any desirable light source (e.g., an incandescent light source, a light emitting diode (LED) light source, an infrared light source, a flash lamp, a laser light, a halogen light or the like) that emits visible or non-visible light.

The computing resource 12 may be communicatively-coupled (e.g., wirelessly or hardwired by, for example, the electrical communication conduit 20c) to the light emitting device 16 in order to activate or deactivate the light emitting device 16. In some instances, the wheel, W, is arranged between the light emitting device 16 and the light receiving device 18; further, the light emitting device 16 and the light receiving device 18 are substantially linearly-aligned with the wheel, W. Therefore, upon activation of the light emitting device 16, the light, L, emitted from the light emitting device 16 is directed toward both of the wheel, W, and the light receiving device 18. The computing resource 12 may be communicatively-coupled (e.g., wirelessly or hardwired by, for example, the electrical communication conduit 20d) to the light receiving device 18 in order to receive information associated with or generated by the light receiving device 18; as will be explained in the following disclosure, the information associated with or generated by the light receiving device 18 may contribute to a determination of uniformity (as seen, e.g., in FIG. 2A) or a lack of uniformity (as seen, e.g., in FIG. 2A′) of the wheel, W.

With reference to FIG. 1A, in an example, a first portion, L₁, of the light, L, emitted by the light emitting device 16 may be received by at least a portion of the outer circumference, W_{C}, of the wheel, W, and, a second portion, L₂, of the light, L, emitted by the light emitting device 16 may be received by the light receiving device 18. Because the wheel, W, is arranged between the light emitting device 16 and the light receiving device 18, and, the light emitting device 16 and the light receiving device 18 are substantially linearly-aligned with the wheel, W, the first portion, L₁, of the light, L, received by at least a portion of the outer circumference, W_{C}, of the wheel, W, may result in the wheel, W, casting a shadow, L₁′, upon the light receiving device 18; the shadow, L₁′, that is cast upon the light receiving device 18 may be approximately equal to a portion of a surface area of the outer circumference, W_{C}, of the wheel, W, that receives the first portion, L₁, of the light, L, emitted by the light emitting device 16.

The light receiving device 18 may include, but is not limited to a digital optical imaging device, such as, for example, a charge-coupled device (CCD). Upon receiving the second portion, L₂, of the light, L (that is distinguished by the shadow, L₁′, of a portion of the outer circumference, W_{C}, of the wheel, W), the CCD 18 may create a bi-pixel digital image that is then converted into an electronic signal; the electronic signal is then communicated from the CCD 18 to the computing resource 12 (e.g., wirelessly or hardwired by, for example, the electrical communication conduit 20d).

As seen in FIG. 1A, the shadow, L₁′, formed by a portion of the outer circumference, W_{C}, of the wheel, W, generally corresponds to at least a portion of a cross-section taken across a portion of the wheel, W. Therefore, as the wheel, W, is rotated, R, by the implement rotating device 14, the shadow, L₁′, formed by a portion of the outer circumference, W_{C}, of the wheel, W, should be substantially similar over a full 360° revolution of the wheel, W, when the portion of the outer circumference, W_{C}, of the wheel, W, does not include an imperfection or lack of uniformity (as seen, e.g., in FIG. 2A, the bi-pixel digital image formed shadow, L₁′, defined by the wheel drop center, W_{DC}, may be recognized by the software associated with the computing device 12 as having a true radius, W_{DC-R}). However, in an instance where a portion of the outer circumference, W_{C}, of the wheel, W, may include an imperfection or lack of uniformity, a portion, L₁′-I, of the shadow, L₁′, defined by the outer circumference, W_{C}, of the wheel, W, may exhibit an interruption of an expected, benchmark true radius, W_{DC-R}, of the wheel drop center, W_{DC} (i.e., seen, e.g., in FIG. 2A′, the bi-pixel digital image formed shadow, L₁′, defined by the wheel drop center, W_{DC}, may be recognized by the software associated with the computing device 12 as deviating from the true radius, W_{DC-R}, of the wheel drop center, W_{DC}, and, therefore, the software associated with the computing device 12 may flag the wheel, W, as exhibiting an imperfection or lack of uniformity).

Therefore, in some implementations, the software associated with the computing device 12 may be programmed in a manner that may determine or detect any deviation of, for example, one or more bi-pixel images created by the CCD 18 from a benchmark image (e.g., a bi-pixel depiction of a wheel drop center, W_{DC}, having an unadulterated radius, W_{DC-R}) when the outer circumference, W_{C}, of the wheel, W, includes at least one occurrence of an imperfection or lack of uniformity. Alternatively, when, for example, a plurality of bi-pixel images of the wheel, W, that are captured over a full 360° revolution of the wheel, W, are substantially similar and exhibits no deviation from a benchmark image, the software associated with the computing device 12 may alert an operator of the uniformity testing system 10 that the wheel, W, is rotationally balanced, uniform, or in some other way non-defective for its intended purpose.

In some instances, second portion, L₂, of the light, L (that is distinguished by the shadow, L₁′, of the wheel, W), that is received by the light receiving device 18 may not be substantially similar over a full 360° revolution of the wheel, W, as a result of, for example, a valve stem, VS (see, e.g., FIG. 1A), extending from a sidewall of the wheel, W. Therefore, in some instances where a valve stem, VS, prohibits an expected symmetry of the second portion, L₂, of the light, L (that is distinguished by the shadow, L₁′, of the wheel, W), to occur over a full 360° revolution of the wheel, W, the software may be programmed to discount an expected lack of symmetry (arising from, e.g., the valve stem, VS); alternatively, for example, the software may be programmed to focus on a zone of the wheel, W (such as, for example, wheel drop center, W_{DC}) that may be compared to a benchmark image that will have an expected, repeatable image over a full 360° revolution of the wheel, W.

Referring to FIG. 3, a method 100 for utilizing the uniformity testing system 10 is now described. The method 100 may include the step of: arranging S.101 the implement rotating device 14 between the light emitting device 16 and the light receiving device 18. The method 100 may also include the step of: arranging S.102 the wheel, W, upon the implement supporting portion 14b of the implement rotating device 14. The method 100 may further include the step of: utilizing the computing device 12 for activating S.103 the light emitting device 16 for directing emitted light, L, toward both of the wheel, W, and the light receiving device 18; alternatively, a user may manually activate S.103 the light emitting device 16. The method 100 may also include the step of: receiving S.104 a first portion, L₁, of the emitted light, L, upon at least a portion of the outer circumference, W_{C}, of the wheel, W, and receiving a second portion, L₂, of the emitted light, L, upon the light receiving device 18 such that the wheel, W, casts a shadow, L₁′, upon the light receiving device 18.

The method 100 may also include utilizing the computing device 12 for activating S.105 the rotating device 14a of the implement supporting portion 14 for imparting rotation, R, to both of the implement supporting portion 14b and the wheel, W; alternatively, a user may manually activate S.105 rotating device 14a of the implement supporting portion 14 for imparting rotation, R, to both of the implement supporting portion 14b and the wheel, W. After activating S.105 the rotating device 14a, the method 100 may include the step of utilizing the computing device 12 for increasing S.106 rotational speed of the implement supporting portion 14b; alternatively, a user may manually increase S.106 rotational speed of the implement supporting portion 14b.

After increasing S.106 the rotational speed of the implement supporting portion 14b, the method 100 may include the step of utilizing the computing device 12 for determining S.107 if the implement supporting portion 14b has reached a predetermined rotational speed; if the implement supporting portion 14b has not yet reached the predetermined rotational speed, the method 100 may be looped back to step S.106 for increasing the rotational speed of the implement supporting portion 14b. However, if the implement supporting portion 14b has reached the predetermined rotational speed, the method 100 may be advanced from step S.107 to step S.108.

At step S.108, the method 100 may include the step of utilizing the light receiving device 18 for capturing at least one image (such as, e.g., a bi-pixel image) defined by the second portion, L₂, of the emitted light, L, and the shadow, L₁′, formed by the wheel, W, over at least, for example, one full revolution of the wheel, W. The method 100 may also include the step of analyzing S.109 the captured at least one image for determining uniformity (see, e.g., FIG. 2A) or a lack of uniformity (see, e.g., FIG. 2A′) of the wheel, W.

In some implementations, the light receiving device 18 in conjunction with the computing resource 12 may be operational to capture S.108 images (defined by the second portion, L₂, of the light, L, and the shadow, L₁′, of the wheel, W) at any desirable frame rate ranging between approximately 30 frames-per-second and 1,000 frames-per-second. In some instances, the light receiving device 18 may be sized or positioned S.101 in a manner in order to permit the computing resource 12 to investigate a particular area of interest of the wheel, W (e.g., an area of the wheel, W, such as, for example, the wheel drop center, W_{DC}, that is less than an entire portion of the outer circumference, W_{C}, of the wheel, W). In another example, the light receiving device 18 may be sized or positioned S.101 in a manner in order to permit the computing resource 12 to investigate an entire outer circumference, W_{C}, of the wheel, W; in such an exemplary embodiment, a field of view of the light receiving device 18 may be dependent upon the physical size of the wheel, W, and a distance between the light emitting device 16 and the wheel, W. In some instances, a field of view of the light receiving device 18 for capturing at least a portion of an image (defined by the second portion, L₂, of the light, L, and the shadow, L₁′, of the wheel, W) may be equal to approximately about 144 millimeters by 108 millimeters.

The light receiving device 18 may have any desirable pixel resolution. In one example, the light receiving device 18 may have a pixel resolution equal to approximately about 0.056 inches. Any desirable image processing software package may be utilized to enable location of sub-pixel edges of the wheel, W (defined by the second portion, L₂, of the light, L, and the shadow, L₁′, of the wheel, W), using best fit algorithms. In an example, if a light imaging device 18 having field of view equal to approximately about 144 millimeters by 108 millimeters and a pixel resolution equal to approximately about 0.056 inches is utilized, a point accuracy of approximately about 0.010 inches may be obtained.

Depending on the number of frames to be captured by the computing device 12 and the rotational speed of rotator 14a, the wheel, W, may be rotated, S.105, by the rotator 14a between approximately four and ten seconds. In some instances, the angular rotation detector 14c may encode an angular position of the wheel, W, as the wheel, W, rotates through its 360° cycle. The angular rotation information generated by the angular rotation detector 14c may be sent to computing device 12 such that the computing device 12 may synchronize each image of a series of images captured by the light receiving device 18 with an absolute angular position of the wheel, W, as each image of the series of images was captured S.108 by the light receiving device 18. Once a desired amount of images are captured S.108 over at least, for example, one full 360° revolution of the wheel, W, the computing device 12 may send a signal to the rotator 14a to cease rotation of the implement supporting portion 14b and the wheel, W.

Referring to FIG. 1A, the uniformity testing system 10 may also include one or more pedestals 22a-22c arranged upon an underlying ground surface, G. Each pedestal 22a-22c may be disposed adjacent and support, respectively, the implement rotating device 14, the light emitting device 16 and the light receiving device 18. In some instances, each pedestal 22a-22c may be extended or retracted in any X-Y-Z direction (e.g., each pedestal 22a-22c may include telescoping sections or wheels). By permitting each pedestal 22a-22c to be selectively positioned S.101 in any X-Y-Z orientation, one or more of the implement rotating device 14, the light emitting device 16 and the light receiving device 18 may be spatially adjusted relative each other in order to, for example, permit the computing device 12 to investigate all or a particular area of interest of the outer circumference, W_{C}, of the wheel, W.

The uniformity testing system 10 may realize several benefits. In one instance, the uniformity testing system 10 can be utilized as a non-contact wheel dimensioning device for a variety of wheels, W, having different sizes and shapes. For example, the shadow, L₁′, that is cast on light receiving device 18 may be proportionally larger for larger wheels, W, than it would be for smaller wheels, W; so, if, for example, the light emitting device 16 and the light receiving device 18 are placed at predetermined distances from each other and at predetermined distances from the implement rotating device 14, the shadow, L₁′, cast on the light receiving device 18 may be proportionately larger for a larger wheel, W (e.g., a 14″ wheel, W, will cast a larger shadow on the light receiving device 18 than that of a 13″ wheel, W; likewise, a 15″ wheel, W, will cast a larger shadow, L₁′, on the light receiving device 18 than that cast by a 14″ wheel, W).

In another example, the uniformity testing system 10 may be utilized as a harmonic inspection device (e.g., the computing resource 12 may compare and statistically analyze the frame-to-frame bi-pixel images in order to detect “wobble” or vibrational deviance of the wheel, W). This type of information can be used for any number of purposes including, determining whether the wheel, W, is within acceptable limits for “out of roundness,” or, out of limits for vibrational tolerances. Also, other harmonic information may be able to be gleaned, such as, for example, predominant resident frequencies of vibration that might be established by the wheel, W, as a function of, for example, rotational speed of the wheel, W.

In yet another example, the uniformity testing apparatus 10 may be utilized for the purpose of a match marking operation. As described above, the “high spot” of the wheel, W, may be matched to a “low spot” of the tire, T, during the a mounting process where the tire, T, is joined to the wheel, W, for forming a non-inflated tire-wheel assembly, TW_{NI}. When the wheel, W, is matched with the tire, T, the matching procedure may minimize an amount of ancillary weights applied to the non-inflated tire-wheel assembly, TW_{NI}, when a balancing operation of the non-inflated tire-wheel assembly, TW_{NI}, is carried out. If the offsetting high spot of the wheel, W, can be matched with the low spot of the tire, T, during the assembly process, less weight is added to the non-inflated tire-wheel assembly, TW_{NI}, than would otherwise have to be added if this match marking process was not done. Accordingly, the high spot of the wheel, W, may be algorithmically determined by software as a result of data being provided to the computing device 12 by one or more of the angular rotation detector 14c and the light receiving device 18 (by virtue of the fact of being able to synchronize the high spot that occurs on a given frame). Likewise, a low spot of a tire, T (that is unmounted to a wheel, W), can be determined in a substantially similar manner. Once the high spot of the wheel, W, and the low spot of the tire, T, are determined, these two spots can be aligned during the mounting process thereby minimizing the number of ancillary weights that are applied to the non-inflated tire-wheel assembly, TW_{NI}, for balancing the non-inflated tire-wheel assembly, TW_{NI}.

In another example, the uniformity testing apparatus 10 may be utilized for the purpose of determining a dimension of the wheel, W, by way of harmonic inspection with a marker. In some instances, an area of the wheel, W, may be dimensioned utilizing a backlighted camera. In such an embodiment, the system 10 would be able to measure a variety of wheel diameters and widths without moving or setting up sensors. The wheel, W, may be rotated between a camera 18 and a light source 16, and, as a result, the system 10 would generate dimensional data that could be compared to an encoder 14c and a stem hole, which would then display or position the wheel, W, to be marked appropriately as a low point (would be utilized for a match marking). The camera 18 may be adjustable in an X-Y-Z orientation in order to accommodate a variety of diameters (e.g., 15″ or 18″ diameter) of wheels, W.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A system for testing an implement, comprising:
a computing resource;
an implement rotating device that rotatably-supports the implement, wherein the implement rotating device is communicatively-coupled to the computing resource;
a light emitting device communicatively-coupled to the computing resource; and
a light receiving device communicatively-coupled to the computing resource, wherein the implement rotating device and the implement are arranged between the light emitting device and the light receiving device, wherein the light emitting device and the light receiving device are substantially aligned with the implement rotating device and the implement such that upon activating the light emitting device, light that is emitted by the light emitting device is directed toward both of the implement and the light receiving device whereby the light receiving device captures an image corresponding to a portion of the light emitted by the light emitting device and a shadow formed by at least a portion of the implement, wherein the shadow corresponds to another portion of the light that is not received by the light receiving device, wherein the light receiving device communicates the captured image to the computing resource for determining uniformity or a lack of uniformity of the implement.

2. The system according to claim 1, wherein the captured image is a bi-pixel digital image.

3. The system according to claim 2, wherein the light receiving device is a digital optical imaging device that creates the bi-pixel digital image.

4. The system according to claim 3, wherein the digital optical imaging device is a charge coupled device that converts the bi-pixel digital image into an electronic signal that is communicated from the charge coupled device to the computing resource for contributing to a determination of uniformity or a lack of uniformity of the implement.

5. The system according to claim 1, wherein the computing resource is wirelessly communicatively-coupled to one or more of: the implement rotating device, the light emitting device and the light receiving device.

6. The system according to claim 1, wherein the computing resource is hardwired to one or more of: the implement rotating device, the light emitting device and the light receiving device by one or more electrical communication conduits.

7. The system according to claim 1, wherein the implement rotating device includes:
an implement supporting portion having a proximal end and a distal end; and
a rotator connected to a proximal end of the implement supporting portion, wherein the distal end of the implement supporting portion is connected to the implement, wherein the rotator imparts rotation to the implement supporting portion and the implement.

8. The system according to claim 7, wherein the implement is one of a wheel, a tire, a non-inflated tire-wheel assembly and an inflated tire-wheel assembly.

9. The system according to claim 7, wherein the rotator is one of a hydraulic motor, a pneumatic motor and an electric motor.

10. The system according to claim 7, wherein the computing resource controls the rotator for adjusting the rotational speed of the implement supporting portion.

11. The system according to claim 7, wherein the implement rotating device further includes:
an angular rotation detector that is disposed upon or connected to the implement supporting portion, wherein the angular rotation detector includes one of an optical disk and magnetic counter.

12. The system according to claim 7, wherein the computing resource receives information associated with or generated by the angular rotation detector that contributes to a determination of uniformity or a lack of uniformity of the implement.

13. The system according to claim 1, wherein the light emitting device is one of an incandescent light source, a light emitting diode (LED) light source, an infrared light source, a flash lamp, a laser light and a halogen light that emits visible or non-visible light.

14. The system according to claim 1, further comprising:
one or more pedestals that are spatially adjustable in an X-Y-Z direction, wherein the one or more pedestals is/are connected to one or more of the implement rotating device, the light emitting device and the light receiving device for selectively adjusting a spatial orientation of one or more of the implement rotating device, the light emitting device and the light receiving device.

15. A method for utilizing a system, comprising the step of:
arranging an implement rotating device between a light emitting device and a light receiving device;
arranging an implement upon a implement supporting portion of the implement rotating device;
activating the light emitting device for directing emitted light from the light emitting device toward both of the implement and the light receiving device;
receiving a first portion of the emitted light upon at least a surface portion of the implement and receiving a second portion of the emitted light upon the light receiving device such that the implement casts a shadow upon the light receiving device;
activating a rotating device of the implement supporting portion for imparting rotation to both of the implement supporting portion and the implement;
utilizing the light receiving device for capturing at least one image defined by the second portion of the emitted light and the shadow formed by the implement over at least one full revolution of the implement;
utilizing the computing device for analyzing the captured at least one image for determining uniformity or a lack of uniformity of the implement.

16. The method according to claim 15, wherein, after activating the rotating device, the method includes the step of
increasing rotational speed of the implement supporting portion; and
after increasing the rotational speed of the implement supporting portion, the method may include the step of
determining if the implement supporting portion has reached a predetermined rotational speed, and, if the implement supporting portion has not yet reached the predetermined rotational speed, the method is looped back to the increasing the rotational speed step, and, upon the implement supporting portion reaching the predetermined rotational speed, the method may exit the loop for advancement to the capturing at least one image step.

17. The method according to claim 15, further comprising the step of:
utilizing an angular rotation detector attached to the implement rotating device for encoding an angular position of the implement as the implement rotates through a rotational cycle for synchronize each captured image of a series of captured images with an absolute angular position of the implement.

18. The method according to claim 15, wherein the capturing at least one image step includes capturing images a frame rate ranging between approximately 30 frames-per-second and 1,000 frames-per-second.

19. The method according to claim 15, wherein the captured at least one image is at least one bi-pixel digital image.

20. The method according to claim 19, wherein the light receiving device is a digital optical imaging device that creates the at least one bi-pixel digital image.

21. The method according to claim 20, wherein the digital optical imaging device is a charge coupled device that converts the at least one bi-pixel digital image into an electronic signal, wherein the method includes the step of
communicating the at least one bi-pixel digital image from the charge coupled device the computing resource.

22. A computer program product encoded on a non-transitory computer readable storage medium comprising instructions that when executed by a data processing apparatus cause the data processing apparatus to perform operations comprising:
activating a light emitting device for directing emitted light from the light emitting device toward both of an implement and a light receiving device such that a first portion of the emitted light is received upon at least a surface portion of the implement and receiving a second portion of the emitted light upon the light receiving device such that the implement casts a shadow upon the light receiving device;
activating a rotating device of the implement supporting portion for imparting rotation to both of the implement supporting portion and the implement and capturing at least one image defined by the second portion of the emitted light and the shadow formed by the implement over at least one full revolution of the implement;
communicating the at least one captured image from the light receiving device to a computing resource; and
analyzing the captured at least one image for determining uniformity or a lack of uniformity of the implement.

23. The computer program product according to claim 22, wherein, after activating the rotating device, the computer program product includes further operations comprising:
increasing rotational speed of the implement supporting portion; and
after increasing the rotational speed of the implement supporting portion, determining if the implement supporting portion has reached a predetermined rotational speed, and, if the implement supporting portion has not yet reached the predetermined rotational speed, further increasing the rotational speed, and, upon the implement supporting portion reaching the predetermined rotational speed, performing the step of capturing the at least one image.

24. The computer program product according to claim 22, further comprising the operation of:
encoding an angular position of the implement as the implement rotates through a rotational cycle for synchronize each captured image of a series of captured images with an absolute angular position of the implement.
